(19) United States
(12) Patent Application Publication
(10) Pub. No.: US 2025/0147549 A1
(43) Pub. Date: May 8, 2025

(54) SPLIT-SCREEN DISPLAY DEVICE

(71) Applicant: Shenzhen E-Tech Digital Technology Co., Ltd., ShenZhen (CN)

(72) Inventor: Yang GU, ShenZhen (CN)

(21) Appl. No.: 18/529,701

(22) Filed: Dec. 5, 2023

(30) Foreign Application Priority Data
Nov. 2, 2023 (CN) 2023229583296

(51) Int. Cl. G06F 1/16

(52) U.S. Cl. CPC G06F 1/1647; G06F 1/1641; G06F 1/1681

(57) ABSTRACT

A split-screen display device includes a clamping frame and at least one display screen. The display screen is provided on the clamping frame, which includes a first bracket and a second bracket. The first and second bracket are connected through at least one tie rod, one end of which is fixed on the second bracket and the other end is inserted into the first bracket. The tie rod is provided with a rack. A spring pin assembly is provided in the first bracket. The spring pin assembly has a tooth head. The spring pin assembly presses the tooth head toward the rack such that the tooth head engages with the rack. When the first bracket and the second bracket are relatively pulled apart, the rebounded tooth head makes a sound when it hits the rack, so a user can enhance the sense of adjustment confirmation through this sound.

### CROSS-REFERENCE TO RELATED APPLICATION

This application claims priority from the Chinese patent application 2023229583296 filed Jan. 2, 2023, the content of which is incorporated herein in the entirety by reference.

### TECHNICAL FIELD

The present disclosure relates to an extended display for a laptop, and more specifically to a split-screen display device.

### BACKGROUND ART

Laptops are one of the common types of computer terminals on the market. Generally, a laptop is composed of a single display screen and a flat computer body. There are also some portable split-screen display devices with single screen, dual screens or triple screens on the market that can be hung on a display screen of a laptop. The attached screens can be rotated and retracted, and a user can use the attached screens for viewing. The substrate of the split-screen display device is divided into two or three parts. Adjacent parts of the substrate are connected through tie rods and can be relatively movable, so that the clamping width of the substrate can be adjusted according to the size of the laptop screen. The previous connecting structures between adjacent parts of the substrate are tie rods and gears. The tie rods are equipped with racks, and the gears engage with the racks. When the adjacent parts of the substrate move relative to each other for width adjustment, due to the stepless adjustment of gear and rack engagement, there is a lack of gear adjustment sound. Some users prefer to enhance the sense of adjustment confirmation by generating sound when adjusting the clamping width, so the previous structures failed to meet the diverse needs of users and needs to be improved.

### SUMMARY

The purpose of the present disclosure is to overcome the above deficiencies in the prior art, and to provide a split-screen display device.

To this end, the present disclosure provides the following technical solution: a split-screen display device, comprising a clamping frame and at least one display screen, wherein the display screen is provided on the clamping frame, the clamping frame comprises a first bracket and a second bracket, the first bracket and the second bracket are connected through at least one tie rod, wherein one end of the tie rod is fixed on the second bracket, and the other end is inserted into the first bracket, a spring pin assembly is provided in the first bracket, the tie rod is provided with a rack, the rack extends along the length direction of the tie rod, the spring pin assembly has a tooth head that is vertically directed toward the rack, and the spring pin assembly presses the tooth head toward the rack such that the tooth head engages with the rack.

Compared with the prior art, in the split-screen display device of the present disclosure, the tooth head of the spring pin assembly engages with the rack, and when the clamping width between the first bracket and the second bracket is adjusted, the first bracket and the second bracket are relatively pulled apart, the tie rod is pulled, and the rack moves linearly relative to the spring pin assembly. During this process, the tooth head is constantly compressed and rebounded. The rebounded tooth head makes a sound when it hits the rack, so a user can enhance the sense of adjustment confirmation through this sound when adjusting the clamping width, thus meeting the diverse needs of the user; and when the tooth head is inserted into a certain tooth valley of the rack, the first bracket and the second bracket can remain fixed at this width, making it less likely to loosen without external force.

The above description is merely an overview of the technical solution of the present disclosure. In order to understand the technical means of the present disclosure more clearly, it can be implemented in accordance with the content of the specification, and in order to make the above and other purposes, features and advantages of the present disclosure more obvious and easier to understand, preferred embodiments are specifically cited below, which are described in detail as follows.

### BRIEF DESCRIPTION OF THE DRAWINGS

FIG. 1 is a three-dimensional diagram of an example of a split-screen display device according to the present disclosure.

FIG. 2 is a three-dimensional diagram of an example of a split-screen display device according to the present disclosure when a first bracket and a second bracket are pulled apart (a display screen is omitted).

FIG. 3 is an internal structural diagram of a first bracket and a second bracket of an example of a split-screen display device according to the present disclosure.

FIG. 4 is an enlarged view of area A in FIG. 3.

FIG. 5 is an internal structural diagram of a first bracket and a second bracket of an example of a split-screen display device according to the present disclosure.

FIG. 6 is an exploded diagram of a tie rod and a rack of an example of a split-screen display device according to the present disclosure.

FIG. 7 is a three-dimensional diagram of an example of a split-screen display device with a single display screen according to the present disclosure.

FIG. 8 is a three-dimensional diagram of an example of a split-screen display device with a single display screen according to the present disclosure.

FIG. 9 is a three-dimensional diagram of an example of a split-screen display device with dual display screens according to the present disclosure.

It should be noted that the products shown in the above views have been appropriately reduced/enlarged to adapt to the size of the drawing and the clarity of the view, and there are no restrictions on the sizes of the products shown in the views.

### DETAILED DESCRIPTION OF EMBODIMENTS

In order to make the purpose, technical solution and advantages of the present disclosure clearer, the present disclosure will be further described in detail below in conjunction with the accompanying drawings and specific embodiments.

The technical solution of the embodiments of the present disclosure will be described below clearly and comprehensively in conjunction with the drawings of the embodiments of the present disclosure. Clearly, the embodiments described are merely some embodiments of the present disclosure and are not all the possible embodiments. Based on the embodiments given in the present disclosure, all other embodiments that would be obtained by those skilled in the art without expending inventive effort shall all fall within the scope of protection of the present disclosure.

In addition, terms “first” and “second” are used merely for descriptive purposes and should not be construed as indicating or implying relative importance or implicitly indicating the number of technical features indicated. Thus, features defined with “first” and “second” can explicitly or implicitly comprise one or more of the features. In the description of the present disclosure, the meaning of “a plurality of” is two or more, unless otherwise explicitly and specifically defined.

In the description of this specification, descriptions with reference to terms “one embodiment”, “some embodiments”, “an example”, “a specific example”, or “some examples” etc., mean specific features, structures, materials or characteristics described in conjunction with the embodiment(s) or example(s) are included in at least one embodiment or example of the present disclosure. In this specification, the schematic representation of the above-mentioned terms should not be constructed as necessarily referring to the same embodiment or example. Moreover, the described specific features, structures, materials or characteristics may be combined in any one or more embodiments or examples in a suitable manner. In addition, those skilled in the art may combine different embodiments or examples described in this specification.

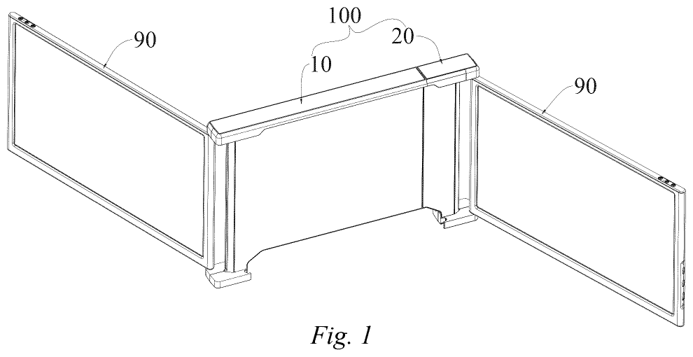

An embodiment of the present disclosure relates to a split-screen display device, and its specific structure is shown in FIGS. 1 to 6.

As shown in FIG. 1, the split-screen display device includes a clamping frame 100 and two display screens 90. When in use, the clamping frame 100 is used to clamp onto the back of a display screen of a laptop. The clamping frame 100 includes a first bracket 10 and a second bracket 20, and the two display screens 90 are respectively provided on the left and right sides of the clamping frame 100. The first bracket 10 and the second bracket 20 can be pulled apart relative to each other to adjust the clamping width.

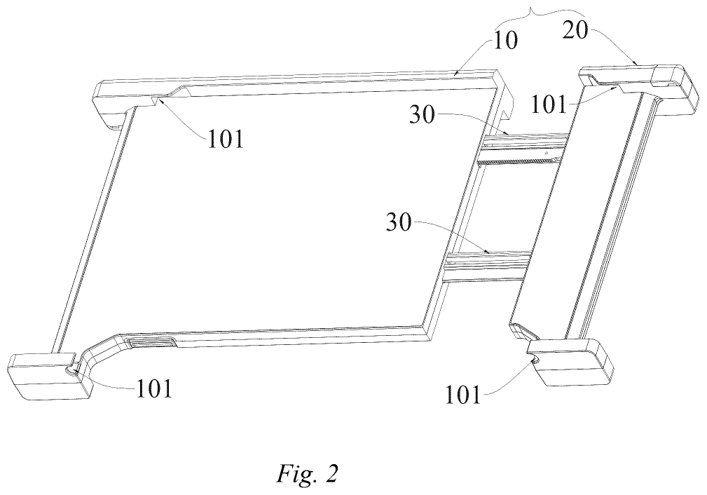

As shown in FIG. 2, the first bracket 10 and the second bracket 20 are connected through two tie rods 30. One end of the tie rod 30 is fixed on the second bracket 20 and the other end is inserted into the first bracket 10. The tie rods 30 can be made of aluminum profiles. In FIG. 2, there are two parallel tie rods 30. In other embodiments, it is also possible to use only one tie rod in the middle to connect the first bracket and the second bracket.

In addition, as shown in FIG. 2, latching slots 101 are respectively provided at the upper left corner, lower left corner, upper right corner and lower right corner of the clamping frame 100. When in use, the upper two latching slots 101 are used to be stuck on the left and right top corners of the laptop screen, and the lower two latching slots 101 are used to be stuck on the left and right sides of the laptop screen.

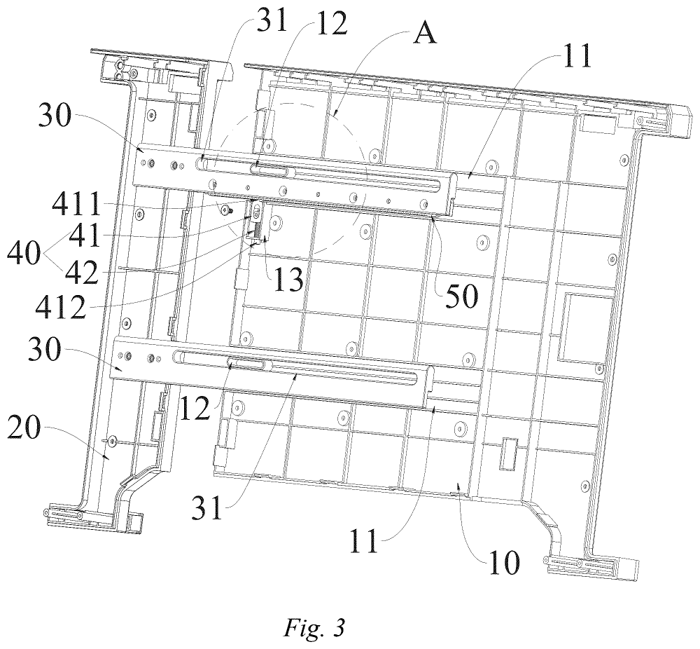

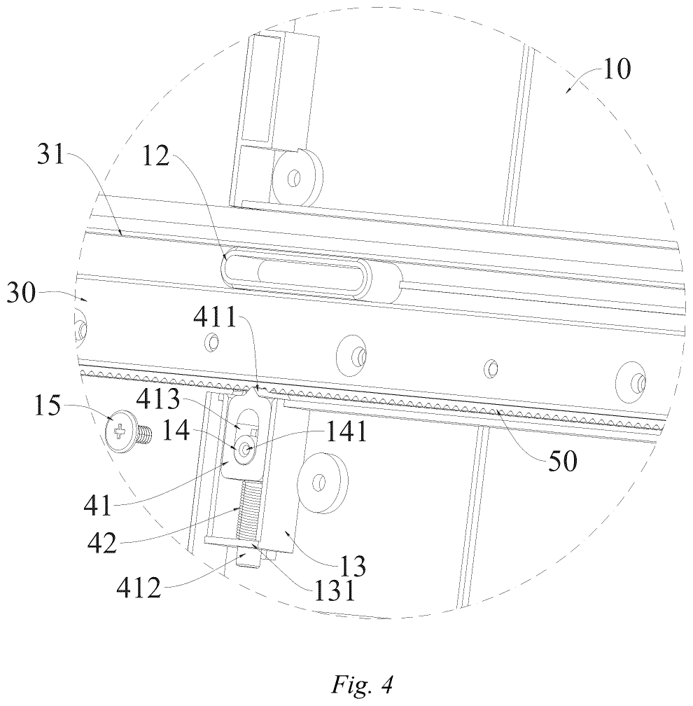

As shown in conjunction with FIG. 3 and FIG. 4, a spring pin assembly 40 is provided in the first bracket 10. Specifically, the spring pin assembly 40 includes an ejection pin 41 and a compression spring 42. The spring pin assembly 40 has a tooth head 411. The tooth head 411 is provided at one end of the ejection pin 41. The other end of the ejection pin 41 is a guide rod 412. The guide rod 412 penetrates through the compression spring 42. The ejection pin 41 can be made of highly wear-resistant POM material, and the tooth head 411 is integrally formed with the ejection pin 41. The tie rod 30 is fixedly provided with a rack 50, and the rack 50 extends along the length direction of the tie rod 30. The tooth head 411 of the ejection pin 41 is vertically directed toward the rack 50, and the spring pin assembly 40 presses the tooth head 411 toward the rack 50 such that the tooth head 411 engages with the rack 50. In an embodiment, the compression spring 42 is deformed under pressure, and the restoring force of the compression spring 42 will push the ejection pin 41 toward the rack 50, such that mutual pressure is formed between the tooth head 411 and the rack 50. When the tooth head 411 is inserted into a certain tooth valley of the rack 50, the thrust of the compression spring 42 on the ejection pin 41 causes the tooth head 411 to be pressed tightly in the tooth valley, so the first bracket 10 and the second bracket 20 can remain fixed in this position, making it less likely to loosen without external force.

When a user uses the split-screen display device, if there is a need to adjust the clamping width between the first bracket 10 and the second bracket 20, the first bracket 10 and the second bracket 20 are relatively pulled apart or retracted, and the tie rod 30 moves linearly with respect to the first bracket 10, such that the rack 50 moves linearly with respect to the spring pin assembly 40. During this process, the tooth head 411 is constantly compressed and rebounded. When the tooth head 411 rebounds, it is pushed by the restoring force of the compression spring 42, so that every time the tooth head 411 passes over a tooth, it will hit the rack 50 and make a sound. Therefore, the user can enhance the sense of adjustment confirmation through this sound when adjusting the clamping width, which can meet the diverse needs of the user.

In other embodiments, the spring pin assembly can also be replaced by a top ball screw, which has a ball at the top and a spring inside to abut against the ball. When the rack moves linearly, the ball is constantly compressed and rebounded, and the same effect can also be obtained.

In some embodiments, as shown in conjunction with FIG. 3 and FIG. 4, a vertical guide groove 13 is provided in the first bracket 10. The length direction of the guide groove 13 is perpendicular to the rack 50, and the ejection pin 41 and the compression spring 42 are both provided in the guide groove 13. The ejection pin 41 moves linearly along the length direction of the guide groove 13, and the guide rod 412 passes through a bottom plate 131 of the guide groove 13. One end of the compression spring 42 abuts against the bottom plate 131 of the guide groove 13, and the other end abuts against the surface of the ejection pin 41. The restoring force of the compression spring 42 directly acts on the ejection pin 41. In addition, as shown in FIG. 4, the guide groove 13 is provided with a guide post 14, and the ejection pin 41 is provided with a guide hole 413. The guide post 14 passes through the guide hole 413. The function of the guide post 14 is to guide the up and down movement of the ejection pin 41. The guide post 14 has an internal threaded hole 141, and a screw 15 is screwed into the internal threaded hole 141. The outer diameter of the head of the screw 15 is larger than the inner diameter of the guide hole 413, so the screw 15 can block the ejection pin 41 to prevent the ejection pin 41 from detaching from the guide groove 13.

In some embodiments, as shown in conjunction with FIG. 3 and FIG. 4, the tie rod 30 is provided with a limiting hole 31 extending along the length direction of the tie rod 30, the first bracket 10 is provided with a limiting bar 12, and the limiting bar 12 penetrates into the limiting hole 31. The limiting bar 12 is a long bar with two semicircular ends, and its length direction is consistent with the length direction of the tie rod 30. The limiting hole 31 limits the horizontal travel of the limiting bar 12, that is, it limits the maximum travel that the first bracket 10 and the second bracket 20 can be pulled apart from each other.

In some embodiments, as shown in FIG. 3, a transverse guide groove 11 is provided in the first bracket 10, and the tie rod 30 is inserted into the transverse guide groove 11 and moves linearly along the length direction of the transverse guide groove 11. The function of the transverse guide groove 11 is to guide the horizontal movement of the tie rod 30, that is, to limit the relative movement of the first bracket 10 and the second bracket 20 in the horizontal direction.

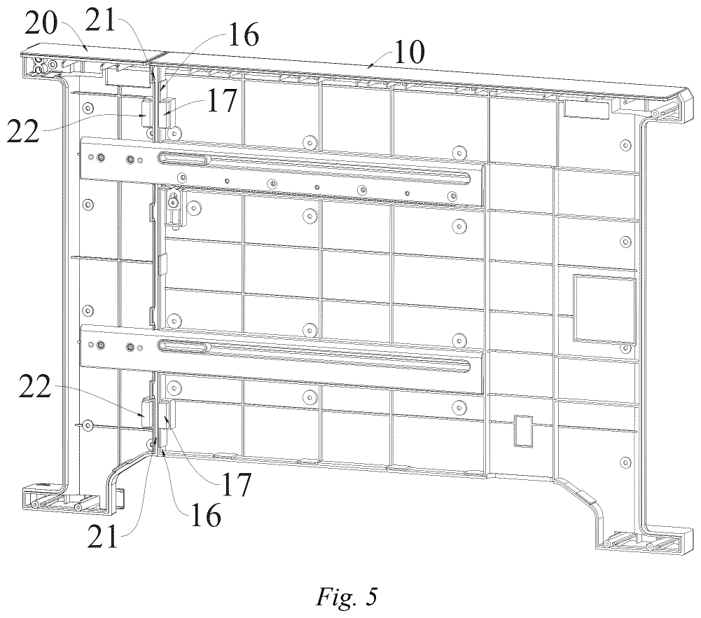

In some embodiments, when the first bracket 10 is attached to the second bracket 20, the first bracket 10 is fixedly attached to the second bracket 20 through magnetic attraction to avoid the occurrence of a gap between the first bracket 10 and the second bracket 20. As shown in FIG. 5, specifically, an inner wall of a side plate 16 of the first bracket 10 facing the second bracket 20 is provided with two first magnets 17, while an inner wall of a side plate 21 of the second bracket 20 facing the first bracket 10 is provided with two second magnets 22, and the positions of the second magnets 22 correspond to the positions of the first magnets 17 one-to-one. Therefore, when the first bracket 10 is attached to the second bracket 20, the first bracket 10 is fixedly attached to the second bracket 20 through magnetic attraction between the first magnets 17 and the second magnets 22. In other embodiments, the first magnets can be replaced with iron blocks, or the second magnets can be replaced with iron blocks to achieve the same magnetic attraction effect.

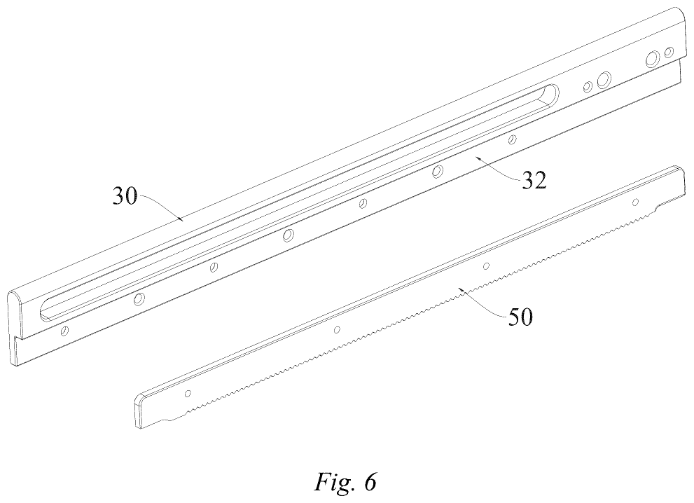

In some embodiments, as shown in FIG. 6, the tie rod 30 is provided with a strip-shaped receiving groove 32 extending along the length direction of the tie rod 30, and the rack 50 is fixedly placed in the strip-shaped receiving groove 32 through a plurality of screws. The rack 50 is also made of highly wear-resistant POM material. In other embodiments, it is also possible that each of the two tie rods is installed and fixed with a rack, and each rack corresponds to a set of spring pin assemblies.

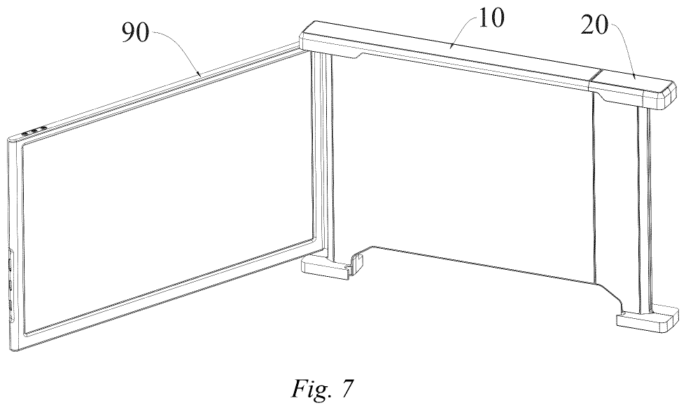

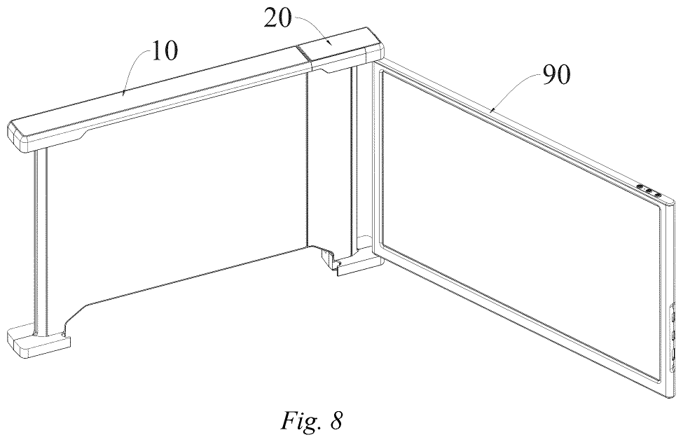

In the example of FIG. 1, the first bracket 10 is hinged with a display screen 90, and the second bracket 20 is also hinged with a display screen 90. In other embodiments, as shown in FIG. 7, it is also possible that only the first bracket 10 is hinged with a display screen 90, and the second bracket 20 is not connected with any display screen. Or, as shown in FIG. 8, only the second bracket 20 is hinged with a display screen 90, and the first bracket 10 is not connected with any display screen.

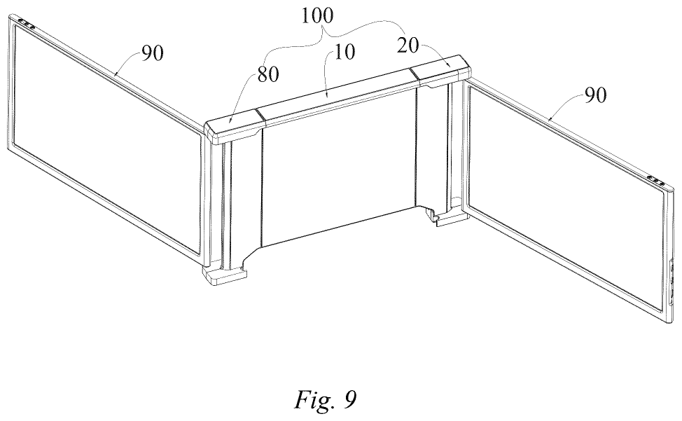

In other embodiments, as shown in FIG. 9, the clamping frame 100 further includes a third bracket 80. The third bracket 80 and the second bracket 20 are symmetrically located on the left and right sides of the first bracket 10, and a connection structure between the third bracket 80 and the first bracket 10 is the same as that between the second bracket 20 and the first bracket 10. In FIG. 9, the second bracket 20 is hinged with a display screen 90, and the third bracket 80 is also hinged with a display screen 90.

The above only uses embodiments to further illustrate the technical content of the present disclosure, so as to make it easier for readers to understand, but it does not mean that the implementation of the present disclosure is limited to this. Any technical extension or re-creation made in accordance with the present disclosure is all protected by the present disclosure. The protection scope of the present disclosure is defined by the claims.

1. A split-screen display device, comprising a clamping frame and at least one display screen, wherein the display screen is provided on the clamping frame, the clamping frame comprises a first bracket and a second bracket, the first bracket and the second bracket are connected through at least one tie rod, wherein one end of the tie rod is fixed on the second bracket, and the other end is inserted into the first bracket, a spring pin assembly is provided in the first bracket, the tie rod is provided with a rack, the rack extends along the length direction of the tie rod, the spring pin assembly has a tooth head that is vertically directed toward the rack, and the spring pin assembly presses the tooth head toward the rack such that the tooth head engages with the rack.

2. The split-screen display device of claim 1, wherein the spring pin assembly comprises an ejection pin and a compression spring, the tooth head is provided at one end of the ejection pin, and the other end of the ejection pin is a guide rod, the guide rod penetrates through the compression spring, and the restoring force of the compression spring pushes the ejection pin toward the rack.

3. The split-screen display device of claim 2, wherein a guide groove is provided in the first bracket, the length direction of the guide groove is perpendicular to the rack, the ejection pin and the compression spring are provided in the guide groove, the ejection pin moves linearly along the length direction of the guide groove, the guide rod passes through a bottom plate of the guide groove, one end of the compression spring abuts against the bottom plate of the guide groove, and the other end abuts against the surface of the ejection pin.

4. The split-screen display device of claim 1, wherein the tie rod is provided with a strip-shaped receiving groove extending along the length direction of the tie rod, and the rack is fixedly placed in the strip-shaped receiving groove.

5. The split-screen display device of claim 1, wherein a transverse guide groove is provided in the first bracket, and the tie rod is inserted into the transverse guide groove and moves linearly along the length direction of the transverse guide groove.

6. The split-screen display device of claim 1, wherein the tie rod is provided with a limiting hole extending along the length direction of the tie rod, the first bracket is provided with a limiting bar, and the limiting bar penetrates into the limiting hole.

7. The split-screen display device of claim 6, wherein the limiting bar is elongated, and its length direction is consistent with the length direction of the tie rod.

8. The split-screen display device of claim 1, wherein when the first bracket is attached to the second bracket, the first bracket is fixedly attached to the second bracket through magnetic attraction.

9. The split-screen display device of claim 8, wherein an inner wall of a side plate of the first bracket facing the second bracket is provided with first magnets, an inner wall of a side plate of the second bracket facing the first bracket is provided with second magnets, and the positions of the second magnets correspond to the positions of the first magnets; the first bracket is fixedly attached to the second bracket through magnetic attraction between the first magnets and the second magnets.

10. The split-screen display device of claim 1, wherein only the first bracket is hinged with a display screen; or, only the second bracket is hinged with a display screen; or, the first bracket is hinged with a display screen and the second bracket is hinged with a display screen.
